(19) United States
(12) Patent Application Publication
(10) Pub. No.: US 2007/0077940 A1
(43) Pub. Date: Apr. 5, 2007

(54) Direction locator for cellular telephone

(76) Inventor: Josef Mamo, Jerusalem (IL)

Correspondence Address: BACON & THOMAS, PLLC, 625 SLATERS LANE, FOURTH FLOOR, ALEXANDRIA, VA, 22314, US

(21) Appl. No.: 10/582,093

(22) PCT Filed:
(86) PCT No.: PCT/IL04/01111

(30) Foreign Application Priority Data
Dec. 8, 2003 (IL) 159252

(51) Int. Cl. H04Q 7/20

(52) U.S. Cl. 455/456.1; 701/200

(57) ABSTRACT

A direction locator for cellular telephone and to a method for using it. More specifically, a compass free and GPS free cellular telephone, having means to direct its user in the direction of predetermined sites on the globes. Also, a method for indicating the direction, to means for such cellular guidance and to a method of ding business from the locator.

### THE FIELD OF THE INVENTION

The present invention generally relates to a direction locator for cellular telephone and to a method for using it. More specifically, the present invention relates to a cellular telephone, having means to direct its user the direction of predetermined sites on the globes. The present invention also relates to a method for indicating said direction, to means for such cellular guidance and to a method of doing business from said locator.

### BACKGROUND OF THE INVENTION

It is an everyday task for hundred of million peoples to find the general direction of a predetermined site on the globe. Hence, Moslems are taught to pray five times a day facing the Holly City of Mecca. Jews are praying three times a day and more towards the general direction of Jerusalem. Other predetermined locations to be directed are to be easily suggested.

Many types of direction locators are commercial products: compasses and any size and shapes, gyro, Global Positioning System (GPS) etc. Nevertheless, those articles are not available for most prayers and other users. Cellular telephones are very popular commodity, yet its use for locating the desired direction is not yet available.

U.S. Pat. No. 5,398,376 to Lemke et al. describes a method for measuring and recording a plurality of geographically located cellular-communication-channel signal strengths in a pedestrian area. This method requires a highly complicated assembly, comprising an antenna, a receiver, a controller, a timer, a computer, and a self-contained navigation system. Said navigation system requires a gun, having an integral laser range-finder and a fluxgate compass operating in a dead-reckoning mode with reference to a target point positioned in or adjacent the pedestrian area under analysis. The method comprises all the steps as follows: (1) selecting a straight-line path segment, having a starting point and an end point along which the analyzer is to be moved within the pedestrian area under analysis; (2) inputting to the controller assigned values which establish an arbitrary or exact geographic position of the starting point; (3) positioning the analyzer at the starting point which is at the beginning of the straight-line path segment; (4) selecting a distant target point in or adjacent the pedestrian area in the direction of travel along the straight-line path segment which target point is beyond the end point of the straight-line path segment and in alignment with the segment; (5) specifying a time interval by which successive and time-based, signal-strength measurements are to be taken by the signal-strength analyzer; (6) aiming the gun at the distant target point to take a bearing measurement of the straight-line path segment; (7) momentarily activating the gun to take a range measurement from the starting point to the distant target point; (8) reporting the range and bearing measurements of the starting point to the backpack controller; (9) moving the signal-strength analyzer at a uniform velocity by human-operator pacing along the straight-line path segment immediately upon the reporting of the range and bearing measurements of the starting point to the backpack controller; (10) resetting the timer to zero and then starting the timer immediately upon starting movement of the signal-strength analyzer along the straight-line path segment; (11) recording the time as timed by the timer required to move the analyzer along the straight-line path segment immediately upon arrival at the end point of the straight-line segment; (12) aiming the gun at the distant target point upon arrival at the end point of the straight-line path segment to measure a lesser range to the distant target point; (13) computing the distance traveled along the straight-line path segment by subtracting in the computer the range measurement for the end point of the straight-line path segment from the range measurement of the starting point of the straight-line path segment; (14) taking cellular system signal-strength measurements using the antenna and receiver at each specified time interval as the signal-strength analyzer is moved at a uniform velocity along the straight-line path segment from the starting point to the end point; (15) time-stamping each signal strength measurement taken during movement of the signal-strength analyzer from the starting point to the end point of the straight-line path segment to position geographically each such measurement along the straight-line path segment; (16) computing upon arrival at the end point the geographic location of each signal-strength measurement taken along the straight-line path segment, using the distance traveled as computed in the computer, the recorded time required to traverse the straight-line path segment, the reported bearing measurement and the specified time interval; and (17) placing in the computer memory the geographic location and signal strength of each measurement taken on and along the straight-line path segment. It is obvious that such a method does not meet the basic requirements of potential users to have a simple to use and low cost direction locator.

U.S. Pat. No. 6,430,498 to Maruyama et al. presents a portable terminal with the function of walking navigation. Said terminal essentially including (1) a device for getting location information denoting a present place of said portable terminal; and (2) a device for getting direction information denoting an orientation of said portable terminal. The direction and a distance of a destination from said present place are denoted according to the Maruyama's invention with an orientation and a length of a line that is distinguished between starting and ending points. Said vector supplies route guidance information as said walking navigation information.

In this respect that an ordinary user of a direction orientation is only occasionally walking and almost never navigating in unfamiliar locations, yet the user is standing in a more or less fix position and asking the device to screen the general direction to a predetermined sites.

U.S. Pat. No. 6,069,585 to Lanciaux introduces a personal direction finding apparatus for determining the direction to be followed in order to reach a predetermined spot. Said acoustical apparatus includes a headset provided with two earphones and a circuit for generating a track error signal. An everyday use is such an instrument for a rapid and convenient is thus seems tedious and even impossible.

### SUMMARY OF THE INVENTION

It is thus a primary goal of the present invention to provide a useful method for locating the direction between a user's site to a predetermined geographical site by means of a cellular telephone. Said method comprising the following four steps: (i) The self-direction and/or position of said telephone is determined. (ii) The location of said desired site is calculated. (iii) The direction of said desired site from the said determined location of said telephone is calculated. Lastly, step (iv) Said calculated direction on the screen of the telephone is presented. This telephone is essentially having means for determining its direction towards the north and/or its self-location.

It is also in the scope of the present invention, wherein the aforementioned method comprising the following steps: (i) A first direction and/or position of the cellular telephone is determined by means of receiving communication signs from a plurality of communication transducers and so calculating said second location of said telephone. (ii) Said telephone is transferred for a predetermined distance in certain direction. (iii) A second direction and/or position of the cellular telephone is determined by means of receiving communication signs from a plurality of communication transducers and so calculating said second location of said telephone. (iv) The location of said desired site is calculated. (v) The direction of said desired site is determined from the said second determined location of said telephone. Lastly, (vi) Said calculated direction on the screen of the telephone is presented. It is acknowledged that according to the present invention, the communication transducers and/or transceivers are selected from means for cellular communication network. Preferably, those means are selected from a plurality of communication satellites and or communication transceivers and/or transducers providing the cellular communication. In addition, it is preferable wherein the cellular telephone is transferred along a distance of about 10 to 50 m, specifically about 20 m in a gradually straight line at any direction.

It is also in the scope of the present invention wherein the cellular telephone is having means for determining its direction towards the north. Said method comprising the following six steps: (i) The direction of said telephone is determined by a magnetic compass and/or a clinometer and/or at least one gyro. (ii) Said telephone is positioned towards the magnetic north. (iii) The communication signs are received from a plurality of communication transducers and so calculating the self-location of said telephone. (iv) The location of said desired site is calculated. (v) The direction of said desired site is calculated from the self-location of said telephone and lastly, (vi) Said calculated direction is presented on the screen of the telephone.

According another embodiment of the present invention, the cellular telephone is having means for determining its self-position. Said method preferably comprising the four steps of (i) The self direction and location of said telephone is determined by means selected from a magnetic compass, a clinometer, sextant, sundial, theodolite, at least one gyro and/or a GPS. (ii) The location of said desired site is determined. (iii) The direction of said desired site from said telephone is calculated. Lastly, (iv) said calculated direction is presented on the screen of the telephone.

It is in the scope of the present invention wherein the cellular telephone is selected from cellular telephones, satellite telephone, wireless telephone, beeper, palm pilot, MIRS, VPN and/or any personal computer having means for such a phone communication. Further, it is according to a preferred embodiment of the present invention wherein the step of presenting of the calculated direction is provided by presenting visually written or graphically drawn notes, signs, arrows, texts and/or hearing voice massages comprising direction instructions. The presenting of the calculated direction is preferably provided by means of a plurality of arrows or equal directing means, projected with or above relevant maps, photos or drawn layer. Moreover, the presenting of the calculated direction is preferably provided in two or three dimensions.

Said presenting step may also comprise of presenting indications characterizing the desired site. Those indications are preferably selected from text, draws, animation, sounds, pictures or video referring the desired location or the way between the user's site towards said desired location. Alternatively or additionally, those indications are adapted to present a calculated distance between the user's site to the desired site.

It is well in the scope of the present invention wherein the predetermined geographical site is selected from Jerusalem, Mecca and/or any other site of importance to religious people. Additionally or alternatively, thee hereto-defined geographical site is selected from buildings, streets, neighborhoods, towns or countries or any other sites of any importance to the community. Still according to another preferred embodiment of the present invention wherein the said predetermined geographical site is selected from banks, companies, entertainment centers fast food merchants, malls and markets, organizations, petrol stations, shops and/or any commercially oriented identities. This predetermined geographical site is also to be selected from roads, car parks, traffic junctions, main stations, railway stations or subways entrances, terminals, seaports and airports. The aforementioned method as defined above is also to be adapted to direct the user in his way to and/or from a predetermined meeting place.

It is also in the scope of the present invention to provide a cellular telephone useful for locating the direction to a predetermined geographical site in the method defined above. This cellular telephone is preferably comprising an antenna adapted to receive communication signs from a plurality of communication transducers; a transmitter having means to emit signs and thus to communicate with said transducers; a microprocessor suitable for processing said detect signs and to calculate the desired location; and a screen suitable for projecting said calculated location. Said telephone is comprising according few embodiments of the present invention means for determining the self-direction and/or location of said telephone, selected from a magnetic compass, a clinometer, sextant, sundial, theodolite, at least one gyro and/or a GPS.

It is still another object of the present invention to provide a useful and cost-effective means for locating the direction between a user's site to a predetermined geographical site by means of a cellular telephone as defmed in any of the above.

It is a further object of the present invention to provide a method for locating the direction between a user's site to a predetermined geographical site by means of a cellular telephone having means for displaying said direction towards the north and said predetermined geographical site. This method comprising the following steps (i) determining the coordinating of the user cellular telephone on the globe; (ii) calculating the location of the predetermined geographical site on the globe; (iii) calculating the direction of said site from the said determined location of said telephone; (iv) positioning said telephone towards the north by an auxiliary means; and then (v) presenting said calculated direction on the telephone's screen. It is in the scope of the present invention wherein the calculations is made in a remote cellular site; and/or wherein the aforementioned method comprising the step of sending a presentation selected from an illustration, animation or an SMS from a remote site to the user's cellular telephone; said presentation comprising indication of calculated north and the desired predetermined geographical site. The auxiliary means may be selected from integrated or non-integrated compass, GPS or any other means adapted to display the north or the magnetic north.

It is lastly another prepuce of the present invention to provide a method of doing business by either tenanting or selling means for locating the direction between a user's site to a predetermined geographical site by means of a cellular telephone to an advertiser, so said advertiser's predetermined location is essentially listed in the menu of the cellular telephone, in the manner users are being exposed to both said advertisers ability to sale its products and/or services; and/or to said advertiser's nearest sites. Said method may comprising the step of enlisting at least one advertiser's predetermined parameters, selected from its location or at least one other commercial properties in the menu of the cellular telephone. Additionally or alternatively, said method may comprising the step of displaying or playing at least one advertisement selected from the advertiser's trademarks, logos, music or sounds to be connected by the user with said advertiser; to its products and/or services and/or to said advertiser's nearest sites.

### BRIEF DESCRIPTION OF THE FIGURES

In order to understand the invention and to see how it may be carried out in practice, a preferred embodiment will now be described, by way of non-limiting example only, with reference to the accompanying drawing, in which

FIG. 1 schematically presents a cellular telephone indicating in its screen the general direction of a predetermined site;

FIG. 2 schematically presents the cellular telephone as presented in FIG. 1, indicating the direction of site B from local site H, and further indicating the distance between the two sites;

FIG. 3 schematically presents a “Religion” page, wherein the cellular telephone as presented in FIG. 1, indicating in said page the direction of the Western Wall located in Jerusalem, Israel, and wherein the local site is the USA;

FIG. 4 schematically presents a “Location” page, wherein the cellular telephone is as presented in FIG. 1, indicating the direction of Israel and wherein the local site is Canada;

FIG. 5 shows a schematic flow chart presenting two methods for determining the site of the user, wherein FIG. 5A comprising a step of moving the cellular telephone for a predetermined distance and FIG. 5B comprising the use of a compass;

FIG. 6 schematically presents an array of three satellites and signs emitters such as cellular telephones and/or GPS module is used;

FIG. 7 schematically presents an array of three communication relays and a cellular telephone, in communication with at least a portion of said array;

FIG. 8 schematically presents a cellular telephone emitting communication signs to be accepted by either an array of communication relays or communication satellites. Said telephone comprising a compass;

FIG. 9 schematically presents the said “Compass Method” to use the cellular telephone as described in FIG. 5, wherein the person using the telephone is located in site P; the user is hence suggested to position the telephone such in the way it shall face the North (N), so the direction to the desired location (J, for Jerusalem) is obtained;

FIG. 10 schematically presents the said “Moving Method” to use the cellular telephone as described in FIG. 5, wherein the user is suggested to press the button so his current location is determined by means of a GPS, than the user is advised to move a predetermined distance and subsequently, the user is instructed to press the button again so the directing arrow shall appear;

FIG. 11 schematically presents a hierarchical list of the pages potentially presented in the menu of a cellular telephone adapted to direct a location;

FIG. 12 schematically presents a cellular telephone displaying an animation of arrows designating Mecca (M) and the calculated north (N); wherein a compass is either integrated or not integrated with said cellular, displaying the magnetic north;

FIG. 13 schematically presents a plurality of illustrations of the calculated north as respect to the desired location (here Mecca);

FIG. 14 schematically presenting the method of calculating the various teta angels between the magnetic north and the desired location, as a function of the user current location;

FIG. 15 schematically presenting flow chart 151, describing one method according to another embodiment of the present invention enabling the user to find the direction towards the nearest location;

FIG. 16 schematically presenting a pathway according to one embodiment of the present invention from point A to point D, wherein A is the initial location and B to D are a series of locations, the arrows connecting the points present a pathway exceeded along this series of predetermined geographical sites; and θ refers to an angle between the calculated north and a predetermined site. More specifically, θ₁ related to the angle between the calculated north and point A, the initial location; angle θ₂ between the calculated north and the first predetermined geographical site, B, etc; and

FIG. 17, schematically presenting a pathway according to another embodiment of the present invention connecting point A to D as described in above, wherein the pathway is presented on top of a map layer.

FIG. 18, schematically presenting a method to locate the direction between a user's site to a predetermined geographical site by means of a cellular telephone having means presenting the users closest surroundings such that the user can easily oriented the cellular telephone in respect to the projected surroundings; said displayed presentation also comprising an arrow to a predetermined location, and at two landmarks adapted to provide a simple orientation means.

### DETAILED DESCRIPTION OF THE FIGURES

The following description is provided, along all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide the cellular telephone having means to direct a location of a predetermined location defined below.

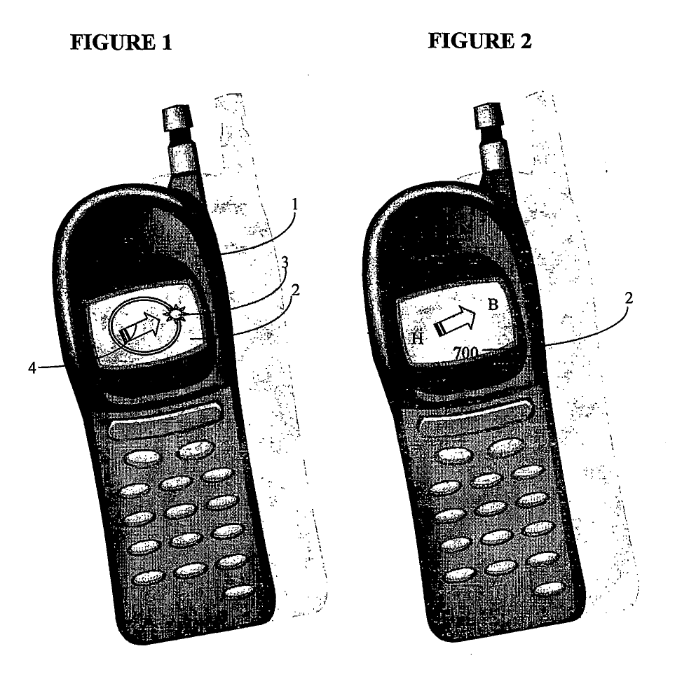

Reference is made now to FIG. 1, schematically presenting a cellular telephone (1) indicating in its screen (2) the general direction of a predetermined site (3) by suitable means, such as a drawn arrow (4) or by any other means.

Reference is made now to FIG., 2 schematically presenting the cellular telephone as presented in FIG. 1, indicating the direction of site B (Bet-Lechem for example) from local site H (e.g., home). According to this embodiment, a calculated distance between the two sites is screen (2).

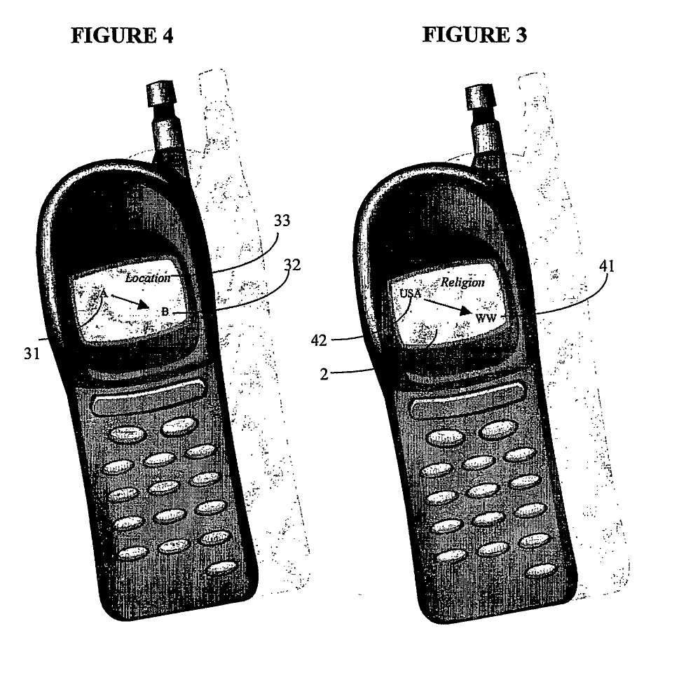

Reference is made now to FIG. 3 presenting schematically another screen of the menu of the cellular, i.e., a “Location” page. According to this embodiment, the cellular telephone is similar to the one presented in FIG. 1., adapted to indicate the direction of a desired street (32) wherein the user is located in street (31). Said embodiment may be altered to a desired neighborhood, city, country, and various special locations, such the Disney World, the adjacent central car park, a commercial identity such as a specific bank, mole, etc.

Reference is made now to FIG. 4, presenting schematically one screen of the cellular's menu, i.e., a “Religion” page. According to this embodiment, the cellular telephone is similar to the one presented in FIG. 1. The cellular's screen (2) is indicating in said page the general direction of the Western Wall (44) located in Jerusalem, Israel, wherein the local site is the USA (42). Said embodiment is especially useful for Jewish people seeking the direction of the Western Wall three times or more per day whereat they are praying their daily prays. Similarly, Muslims are seeking the direction of the Holly City of Mecca five times a day etc.

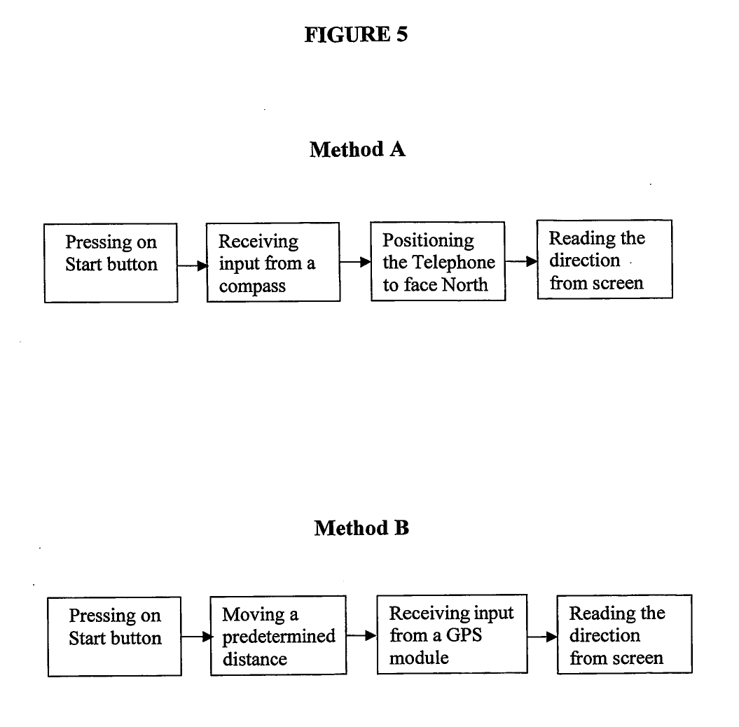

Reference is made now to FIG. 5, showing a schematic flow chart presenting two methods for determining the site of the user, wherein FIG. 5A comprising the use of a compass and FIG. 5B comprising a step of moving the cellular telephone for a predetermined distance. The ‘compass method’ is one method for indication a predetermined location comprising the conceptual steps of indicating the cellular telephone to receive a direction input from the user. Said indication is preferably provided by pressing on a start button of any kind, as predetermined in the operation menu of said telephone. The telephone is now positioned in the manner it is coordinated towards the north to south and/or the East to West directions. Subsequently, with or without indicating the said positioning was completed, e.g., by means of pressing ‘OK’ button, the direction is screen so the user can read it.

In addition or alternatively, a ‘distance method’ is used according to another embodiment of the present invention, which provides a useful method for indicating a predetermined location. Said method comprising the conceptual steps of indicating the cellular telephone to receive direction input from the user, such in the way a ‘start’ button is to be pressed. Subsequently, the user is advised to move a predetermined distance.

An effective distance is usually in the range of 10 to 50 meters, and especially distance of about 20 meters. The length of said distance is depended also by the number and the density of the communication transducers per an area cell, the landscape shape, the utilized technology etc. It is acknowledge thus in this respect that the said effective distance is varied from site to site and shall be reduces constantly.

After receiving a predetermined input from a GPS processing unit, the user is advised to read the desired direction from the screen of the cellular telephone.

It is in the scope of the present invention that the phrase “reading from the screen” of a cellular telephone is referring for any kind of indication techniques, including reading written or graphically drawn notes, signs, arrows, texts etc from a screen of the telephone; to hear voice massages comprising directions, thus suitable more for vision compared persons etc.

It is further in the scope of the present invention, wherein the term ‘cellular telephone’ comprises any of the group of a telephone, such as a cellular, satellite phone and wireless phone, beeper, palms pilot, MIRS, a telephone adapted to a virtual private network (VPN) and personal computer having means for such a phone communication.

Further more, it is in the scope of the direction is provided by the cellular telephone a defined above is in two dimensions or three dimensions.

It is also in the scope of the present invention wherein the aforementioned written or graphically drawn notes as well as voice massages are introduced by the cellular telephone either once or in a plurality of events, online or offline, continuously, in a combination of those or in any other way.

According to another embodiment of the present invention, the user read from the screen is presented with other indications. Such indications may be the distance from the user' site to the desired location to be located, and/other parameters, such as text, draws, sounds, pictures or video referring the said desired location or the way between the user's site towards said desired location. Alternatively or additionally, said indications may be a plurality of arrows or equal directing means presenting means to reach said location, including yet not limited to a map, photo or drawn layer presented together with said indicative means.

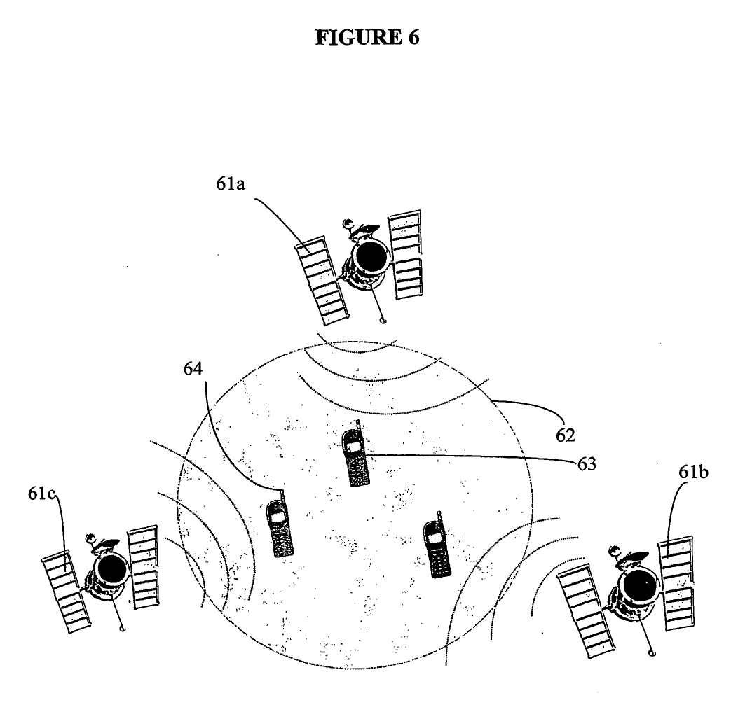

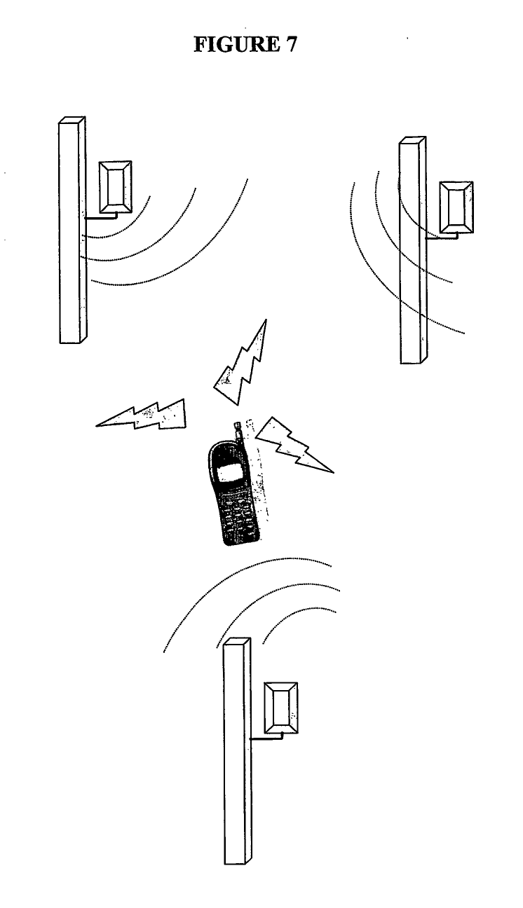

Reference is made now to FIG. 6 schematically presenting an array of communication satellites (61a-61c) in an orbit outside earth (62) and either GPS modules or devices (63) and/or communication emitters comprising a suitable antennae member (64), such as the hereto-defined cellular telephones. Here, three such satellites are illustrated, whereas many more may be utilized. Said plurality of satellites (61a-c) is thus in communication with the GPS and/or cellular telephone (63) in the manner communication signs are processed so the location of said telephone (63) is obtained.

Reference is made now to FIG. 7 schematically presents an array of three communication relays and/or communication transducers (denoted hereby in the short term ‘transducers’) and a cellular telephone, in communication with at least a portion of said array. According to another embodiment of the present invention, the cellular telephone has means to locate its location in a specific cellular network of cells by detecting signal emitted by cellular transducers and thus to determine self location in a given time. Moreover, various technologies currently exist and some are in R&D stages to determine the exact location of the cellular telephone by detecting said emitted signals and subsequently processing said signals to detrained the more or less exact location of the telephone in the said cell.

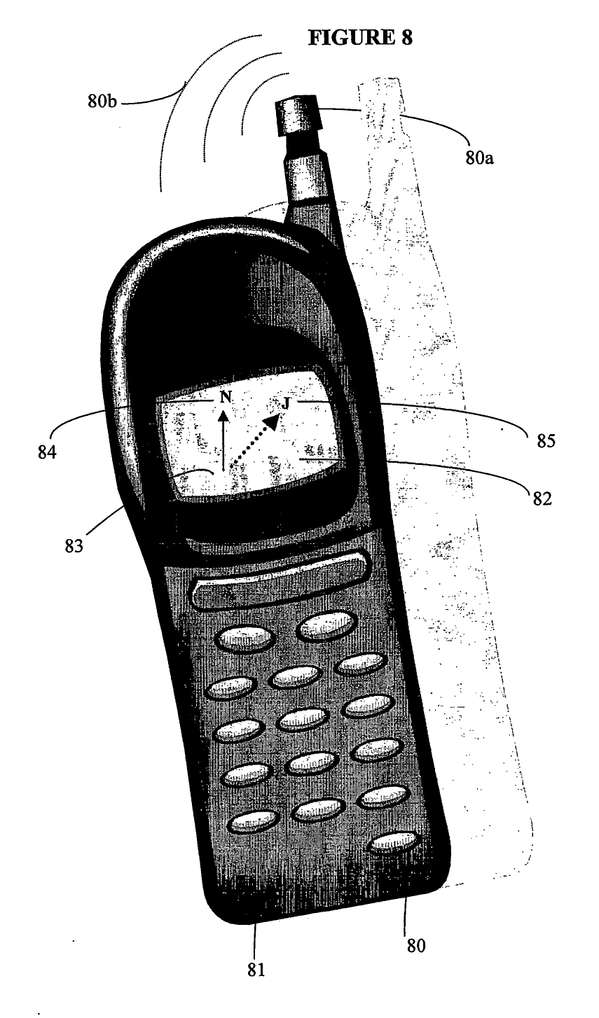

Reference is made now to FIG. 8, schematically presenting a cellular telephone (80) according to another embodiment of the present invention, wherein said telephone is emitting communication signs via its antenna (80a). As defined above, the emitted signal (80b) may to be detected by either (i) an array of communication relays (e.g., transceivers and/or transducers) or (ii) communication satellites. Said telephone comprising a compass (81) of any type, such as a magnetic compass, gyro module or any combination thereof; all denoted in the term ‘compass’. The cellular telephone is adapted to project the user (P, 83) the north (N, 84). After telephone (80) is coordinated such in the way it is facing the north (84), the direction towards the desired location (here J for Jerusalem, 85) is screened.

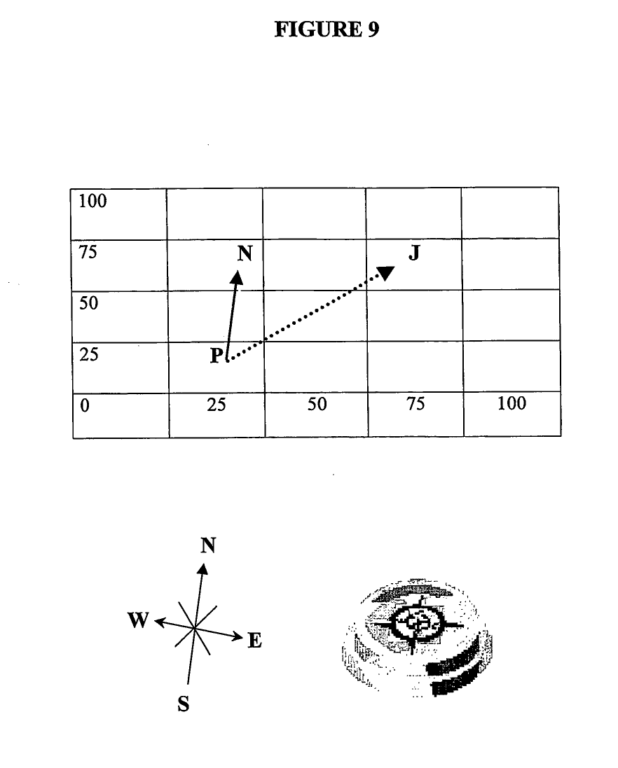

Reference is made now to FIG. 9 schematically presenting a coordinated map of the very same embodiment of the said “Compass Method” to use the cellular telephone as described in FIG. 5, wherein the person using the telephone is located in site P; the user is hence suggested to position the telephone such in the way it shall face the North (N), so the direction to the desired location (J, for Jerusalem) is obtained.

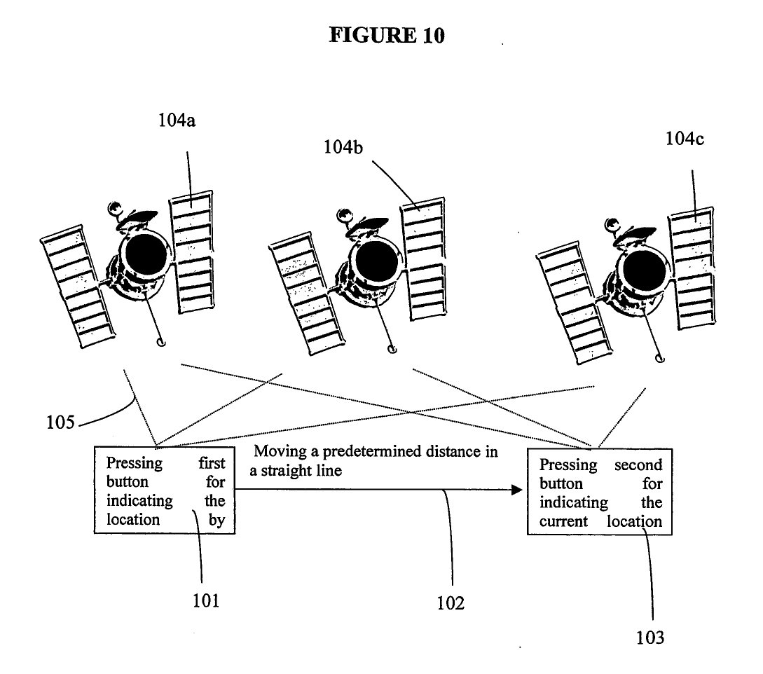

Reference is made now to FIG. 10 schematically presenting the so-called “Moving Method” to use the cellular telephone as previously described in FIG. 5. The user is suggested to press a predetermined button (101), the GPS module communicates (105) with a plurality of satellites (here three, 104a-c) so the current location of the user is determined by means of said GPS. Subsequently, the user is advised to move a predetermined distance (102) and lastly, the user is instructed to press a button again (103) so the directing arrow shall appear.

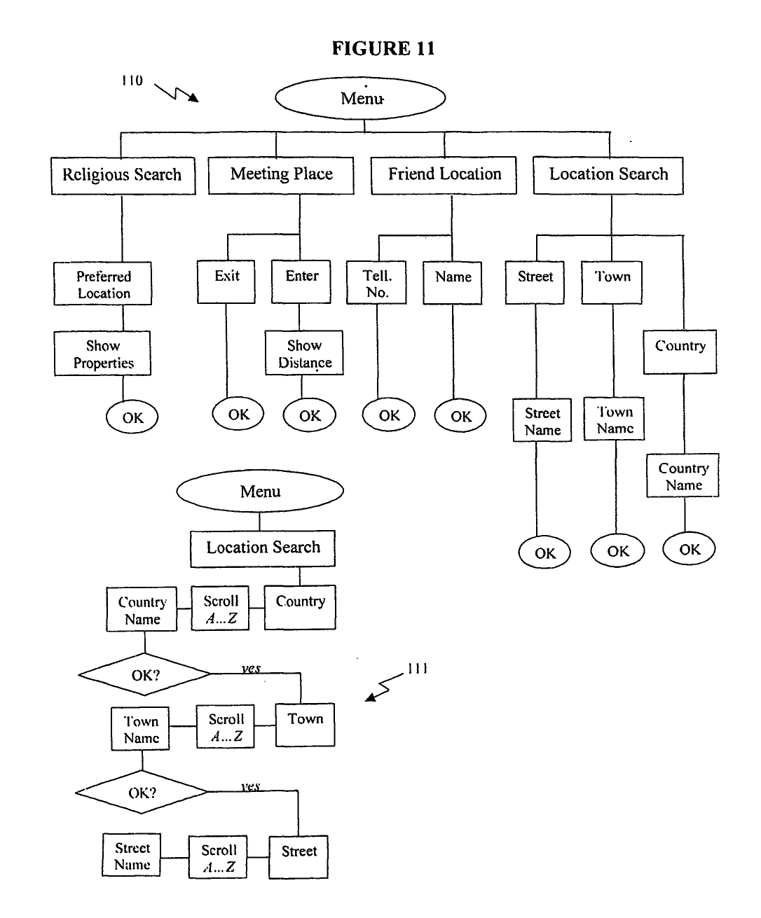

Reference is made now to FIG. 11, presenting a scheme 110 of a hierarchical menu of the cellular page according to one embodiment of the present invention. It is well acknowledged that the said menu is only one simplified example for many other possible menus and/or facilities. The menu thus comprises at least four sub windows though many other windows are possible to be tailored for a specific user or for a cretin user's group. A religious search is a referred for a location directing means adapted for indicating the direction of holly sites, such as Mecca, Jerusalem etc. Usually general direction is enough. According to one embodiment of the present invention, the user is advised to choose at least one such holly site. According to another embodiment, the user is also advised to ask for properties, selected, yet not limited to describing text, relevant video or pictures, preferred music or a pray etc.

A second window comprises a page denoted in the term ‘meeting place’, wherein the user is advised to act in one or more ways as follows: to input a set of coordinates of a site, to choose a meeting site from a predetermined list, comprising for example the local mole, an entertainment center, such as the city theater hole, Disney World, a traffic junction, the local hospital, a police station, a school etc. The user is possibly asked to enter the meeting place, e.g., coming from an initial site to the desired meeting site, or to leave the meeting site to another preferred site.

A third window is adapted to find friend location. The search for said friend can be done by either by the typing or delivering a voice message comprising at least a portion of the friend's name or his telephone number so as the telephone shell identify said friend's cellular telephone. It is in the scope of the present invention wherein the cellular telephone of said friend is located by means defined above, namely by either by processing transducers or satellite communication signs. Preferably following a previous authorization by said friend, the direction from the user to the said friend is provided.

The forth window is hereto denoted in the term ‘location search’. Said plurality of pages comprises either a predetermined list of streets, neighborhoods, towns or countries or alternatively, means to indicate new locations in a coordinated manner.

Flow chart 111 indicated schematically in FIG. 11 shows a method for scrolling the selected target for the “location search” service, according to yet another embodiment of the present invention. While entering the Menu, a location search mode is selected. First, a country search is provided, wherein the user is either typing the desired country name or scrolling a A to Z marker to choose at least the initial character of the country, such that the name stored in a database is obtained. After verifying said country name, the same procedure is preceded for the town, street, street number etc.

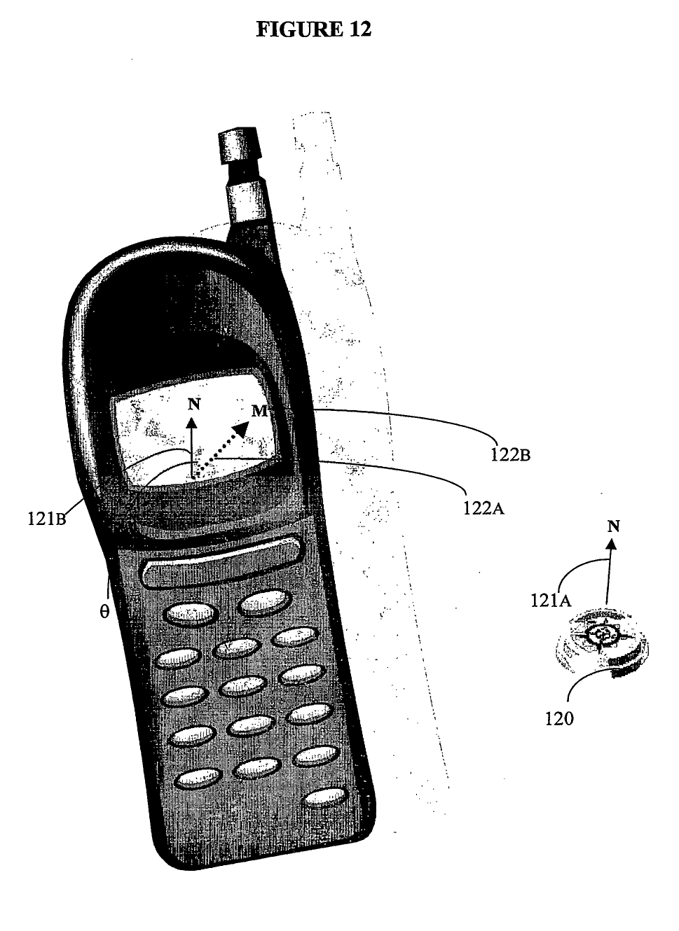

Reference is made now to FIG. 12, schematically presenting a cellular telephone adapted to display an animation of arrows designating Mecca (M) and the calculated north (N); wherein a compass is either integrated or not integrated with said cellular, displaying the magnetic north. The cellular telephone comprising in either integrated or non-integrated manners a compass (120), that is displaying the northern magnetic pole by means of an arrow (121A). Simultaneously, the cellular telephone is receiving an SMS or any suitable illustration or animation of the calculated north (121B), and an arrow or other guiding means (122A) towards the predetermined site (here—Mecca, M) (122B). The user is now correlating the calculated north (121B) with the magnetic north (121A), so the real direction to Mecca (122A) is provided.

It is acknowledged in this respect that the presentation defined above comprising a teta (θ) related to angle between the calculated north (121B) and the predetermined site (122B).

Thus, it is well in the scope of the present invention wherein a useful and cost effective method is provided for locating the direction between a user's site to a predetermined geographical site by means of a cellular telephone having means for diplaying said direction towards the north and said predetermined geographical site. This novel method is comprised the following steps: determining the coordinating of the user cellular telephone on the globe; calculating the location of the predetermined geographical site on the globe; calculating the direction of said site from the said determined location of said telephone; positioning said telephone towards the north by an auxiliary means; and then presenting said calculated direction on the telephone's screen. Potentially, said calculations are made in a remote cellular site. Additionally or alternatively, this method is comprised the step of sending a presentation selected from an illustration, animation or an SMS from a remote site to the user's cellular telephone. This presentation is comprised of an indication of calculated north and the desired predetermined geographical site. It is further in the scope of the present invention wherein the aforementioned auxiliary means is selected from integrated or non-integrated compass, GPS or any other means adapted to display the north or the magnetic north

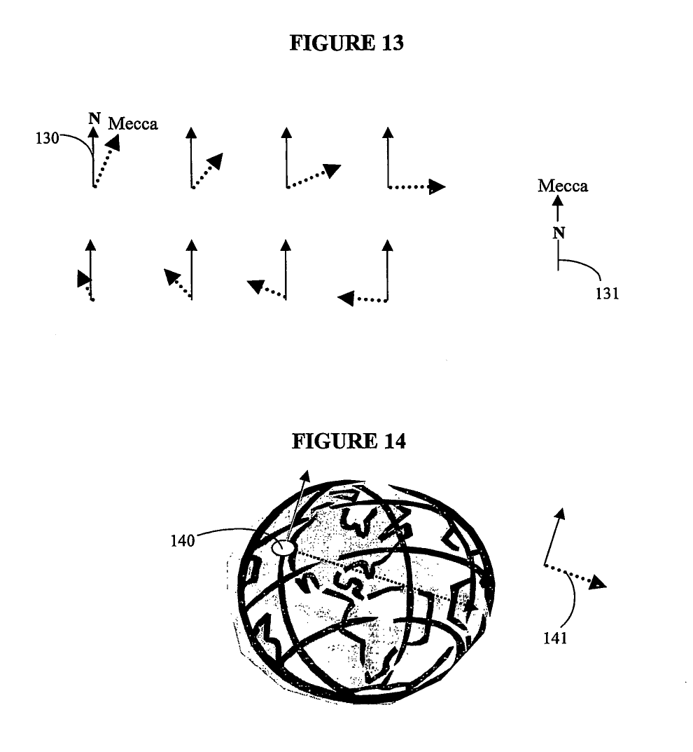

Reference is made now to FIG. 13, schematically presenting a plurality of illustrations of the calculated north as respect to the desired location (here Mecca). It is acknowledge in this respect that those animations (130) are of definite number, especially in case that the direction is provided in low resolution. At the collapse of the predetermined site with the north, presentation (131) is provided.

Reference is lastly made to FIG. 14, schematically presenting the method of calculating the various teta (θ) angels between the magnetic north and the desired location, as a function of the user current location. Here, the user is located at the east cost of the US (140), and the predetermined site is Mecca, so a presentation (141) is provided on the screen of the cellular telephone. The method according to claim 22, wherein the calculations are adapted to calculate a first coordinate; a second coordinate and the angel teta between said two coordinates; wherein said first coordinate is between the user's current site and the calculated North pole; wherein said second coordinate is between said user's current site and the predetermined geographical site.

It is further in the scope of the present invnetion wherein the above-mentioned method is provided, wherein an additional step of presentation of said teta angle is provided. Additionally or alternartively, said method is provided useful wherein a presentation comprising the calculated north and/or south pole, the predetermined geographical site and said teta angle is obtained; so the teta angle which is presented is in coordination to a calculated north and not to the true north.

Moreover, said step may comprising the step of obtaining either the direction to the north pole or to the magnetic north; so the teta angle which is presented is in coordination to the true north. The calculations are possibly made in a remote cellular site; by a means of a processor in communication with said cellular telephone; and/or by a means of a processor integrated in the cellular telephone.

According to yet another embodiment of the present invention, a method of locating the direction between a user's site and a predetermined geographical site is provided useful by means of a cellular telephone adapted to determine its direction towards the north and/or for coordinating itself in the globe. The aforesaid method is comprised of the following general steps: (a) determining the self direction and/or position of said telephone towards the north; (b) either obtaining or calculating the location of said predetermined geographical site (c) calculating the direction of said site from the said determined location of said telephone; and then (d), presenting said calculated direction on the telephone's screen.

More specifically, the said step (b) may be achieved in a non-limited manner by one or more of the following procedures: (i) passive approaches, e.g., obtaining the predetermined geographical site from a server or from a second user located in said site; and/or (ii) active approaches. Hence, in case said user is in communication with a cellular server or operator, by a means of cellular telephone, he may be instructed to permit said cellular server or operator to allocate his positioning (e.g., finding the cellular cell he is currently located) and further to screen it either as a text (e.g., SMS) or others (e.g., by means of an illustration or a pointed arrow presented on the screen of the user's cellular telephone. Said user may be a person using a cellular telephone or either static or dinamic transducer located in any predetermined locations and sites, such as business area, traffic junctions etc.

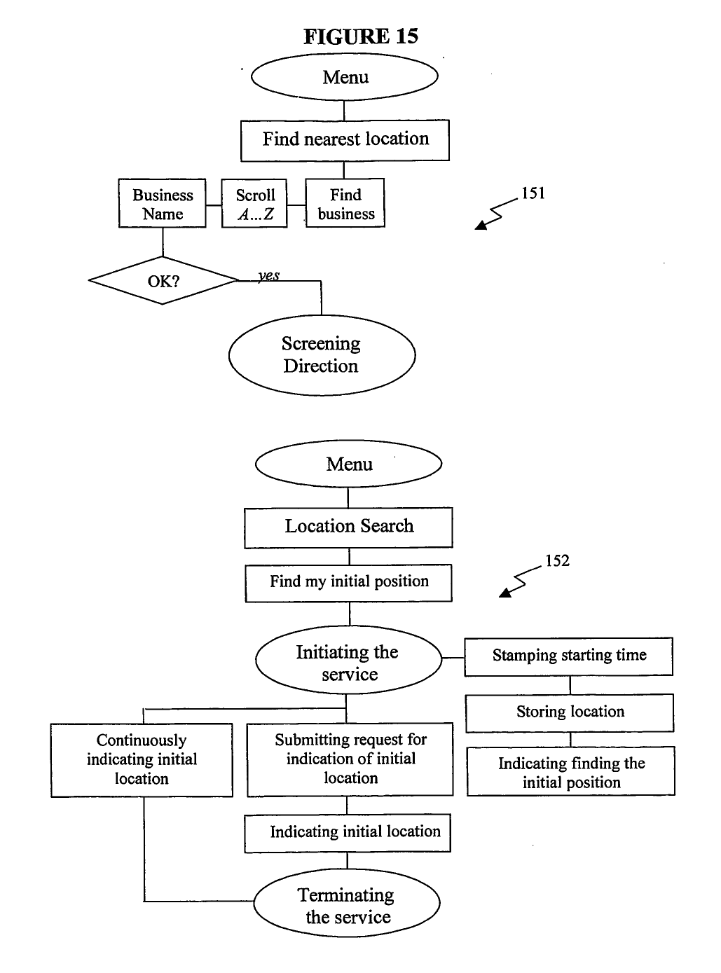

Reference is made now to FIG. 15, schematically presenting flow chart 151, describing one method according to another embodiment of the present invention enabling the user to find the direction towards the nearest location. The term “location” is referring inter alia yet not limited to any service center or a remote service agency; shop; transportation related center, station, junction or the such; immediate care, hospital or the such, wherein said location may be either static in one physical location (bank office for example) or non-static (ice-cream car or mobile post truck for example). Hence for example, the user may select a “find the nearest location” mode in his cellular telephone menu. A screen is now available, instructing the user to type or scroll a “business nearest location”. According to this example, MacDonald Co. is reregistered to this “find the nearest location” cellular service and advertising this service to the public. The user thus scrolls the letter “M” etc until and the MacDonald business name is located in the server. The user then verifies the name “MacDonald”. The location of nearest MacDonald may be provided by any suitable means, e.g., by locating the MacDonald's dinning network on the server (suitable for static businesses), by on-line reading of a cellular signal and thus locating the current cellular cell in which the business is now available (useful for mobile businesses) etc. subsequently, the telephone screen displays directing means, such as an SMS arrow, a coordination etc.

Additionally or alternatively, as provided by yet another embodiment of the present invention, a “find my initial position” mode may be elaborated. Reference is made thus to flow chart 152, schematically presenting a procedure in which the user may locate his previous location. This mode is especially useful for people who travel in the world, and afraid to be lost or to remain far from their hotel. The user may indicating “location search” mode in his cellular telephone, and then select |find my initial position”. Thus, the service is activated and the staring time and/or current location are stamped in a database. An indication for that may be displayed on the screen of the telephone. The location of said “initial position” as been stored in the database may continuously or non-continuously (e.g., every 5 minutes or by traveling from one cellular cell to another) projected in the telephone's screen. Additionally or alternatively, the said initial position is displayed after a direct request of the user, when he or she is submitting a request for indication of the initial location. The initial location is displayed by any means defined above and the current session of the service is terminated. It is in re scope of the present invention wherein the indication of the desired predetermined geographical site is provided by either an delivering SMS massage, drawing arrows, indicating the calculated teta degree, displaying a text or any combination thereof.

It is thus in the scope of the present invention wherein the method adapted to direct the user for and/or from a predetermined meeting place is referring inter alia to any passive or active procedure alocating said meeting place, particularely by alocating a second or more users to be met in said meeting location in a certein cell or cells on cellular network or by other means, such as GPS etc; transferring or communicating said meetng place via the cellular network or other suitable means (e.g., the internet) to the user and then displaying said meeting place by any means as defined and described in the present invnetion.

Such directing step provided the user to alocate a meeting step is useful in both inline or offline systems; in online or delayed manners.

It is also in the scope of the present invention to provide a useful method of locating the direction between a user's site and a plurality of predetermined geographical sites by means of a cellular telephone as defined in any of the above. This telephone is having means for determining its self-direction towards the magnetic north and/or for coordinating itself in the globe. The aforesaid method comprising the steps of determining the self direction and/or position of said telephone towards the magnetic north; calculating the location of the predetermined geographical sites; calculating the direction of said sites from the said determined location of said telephone; and then presenting said calculated directions on the telephone's screen.

It is acknowledged in this respect that the calculated directions are presented in the manner it exceeded from the user's site towards each one of the geographical sites such that a star-like configuration is displayed. Alternatively or additionally, the above-mentioned calculated directions are presented in the manner it exceeded from the user's site towards a series of sequential locations.

More specifically and according to one particular embodiment of the present invention, the aforesaid method is adjusted for locating and presenting a pathway exceeded along a series of predetermined geographical sites, wherein the user initial location is the starting point, by means of a cellular telephone having means for determining its direction towards the north and/or for coordinating itself in the globe. This method comprising inter alia the following steps: determining the initial direction and/or position of the telephone towards the north; calculating the location of the predetermined geographical sites; calculating the direction between said initial site and a series of geographical site; presenting said calculated direction on the telephone's screen; calculating the direction between the first site and a second or more predetermined geographical site; presenting said calculated direction on the telephone's screen; then, repeating the said calculation and presentation for the above mentioned other predetermined geographical sites to obtain a sequential series of directions or a course between the user's site and the predetermined geographical sites.

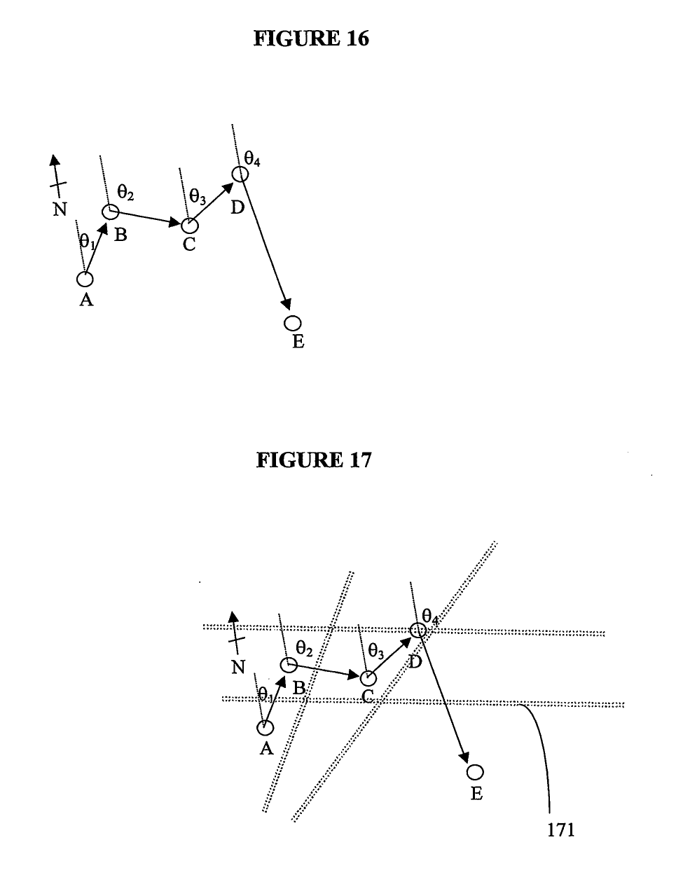

Reference is made now to FIG. 16, schematically presenting a pathway according to one embodiment of the present invention from point A to point D, wherein A is the initial location and B to D are a series of locations, the arrows connecting the points present a pathway exceeded along this series of predetermined geographical sites; and θ refers to an angle between the calculated north and a predetermined site. More specifically, θ₁ related to the angle between the calculated north and point A, the initial location; angle θ₂ between the calculated north and the first predetermined geographical site, B, etc.

Reference is made now to FIG. 17, schematically presenting a pathway according to another embodiment of the present invention connecting point A to D as described in FIG. 16, wherein the pathway is presented on top of a map layer.

It is acknowledged in this respect that the terms ‘map’ and ‘map layer’ are selected in an ono-limiting manner from topographical-maps, road-maps, town-maps, map of a buildinings, a terminals, a car parks or any other maps for any geographical, topographical, urban, transportaion, encoded purposes. Hence for example, the user may be directed to find the shortest pathway from the user's location to a specific address in certain town; in this case the map presents a city map.

According to yet another embodiment of the present invention, the hereto defined method is provided useful wherein the starting point in the above mentioned pathway is any predetermined geographical site, hence, it is not limited to the user initial location site.

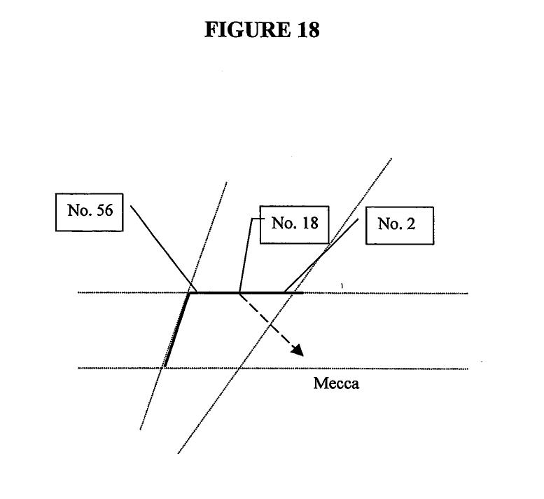

Reference is made now to FIG. 18, schematically presenting another means of presenting a predetermined direction, according to yet another embodiment of the present invention, wherein the road shape is illustrated (See bold r-like shape) and the calculated arrow directing the direction towards Mecca is also illustrated. The user first defines the street and street number (here, the user is at No. 18), the database comprising the street shape is forwarding the said shape to the user display, together with said calculated arrow. It is in the scope of the present invention wherein at least one landmark is co-presented in the display such that the user can orient the said road shape in respect to its surroundings. Such landmarks may be selected in a non-limiting manner from street numbers (here, No. 2 and 56), trees, high buildings, cross sections, water canals etc. In case that no clear roads of landmarks are provided, a far look of the surroundings may also be useful for orientating the display and projected arrow towards the right direction.

1-44. (canceled)

45. A method for locating the direction between a user's site to a predetermined geographical site by means of a cellular telephone having means for determining its direction towards the north and/or the sun and/or the moon for coordinating itself in the globe; said method comprising the following steps;
a. determining the direction and/or position of said telephone towards the north and/or the sun, and/or the moon;
b. calculating the location of the predetermined geographical site;
c. calculating the direction of said site from the said determined location of said telephone; and,
d. presenting said calculated direction on the telephone's screen.

46. The method according to claim 45, further comprising at least one of the following steps;
a. determining a first direction and/or position of the cellular telephone by means of receiving communication signs from a plurality of communication transducers and so calculating said first location of said telephone;
b. transferring said telephone for a predetermined distance in certain direction;
c. determining a second direction and/or position of the cellular telephone by means of receiving communication signs from a plurality of communication transducers and so calculating said second location of said telephone;
d. calculating the location of said desired site;
e. calculating the direction of said desired site from the said second determined location of said telephone; and,
f. presenting said calculated direction on the telephone's screen.

47. The method according to claim 46, wherein the communication transducers are selected from means for cellular communication network, selected from a plurality of communication satellites and or communication transceivers and/or transducers providing the cellular communication.

48. The method according to claim 45, wherein the cellular telephone is selected from cellular telephones, satellite telephone, wireless telephone, beeper, palm pilot, MIRS, VPN and/or any personal computer having means for such a phone communication.

49. The method according to claim 45, wherein the step of presenting of the calculated direction is provided by presenting visually written or graphically drawn notes, signs, arrows, texts and/or hearing voice massages comprising direction instructions.

50. The method according to claim 49 wherein the presenting of the calculated direction is provided by means of a plurality of arrows or equal directing means, projected with or above relevant maps, photos or drawn layer.

51. The method according to claim 45, additionally comprising presenting indications characterizing the desired site.

52. The method according to claim 51, wherein the indications are selected from text, draws, animation, sounds, pictures or video referring the desired location or the way or the distance between the user's site towards said desired location.

53. The cellular telephone according to claim 51, comprising;
a. antenna adapted to receive communication signs from a plurality of communication transducers;
b. transmitter having means to emit signs and thus to communicate with said transducers;
c. a microprocessor suitable for processing said detect signs and to calculate the desired location;
d. a screen suitable for projecting said calculated location.

54. The cellular telephone according to claim 51, additionally comprising means for determining the self-direction and/or location of said telephone, selected from a magnetic compass, a clinometer, sextant, sundial, theodolite, at least one gyro and/or a GPS.

55. A method for locating the direction between a user's site to a predetermined geographical site by means of a cellular telephone having means for displaying said direction towards the north and/or the sun and/or the moon and said predetermined geographical site; said method comprising the following steps;
a. determining the coordination of the user cellular telephone on the globe;
b. calculating the location of the predetermined geographical site on the globe;
c. calculating the direction of said site from the said determined location of said telephone; and
d. positioning said telephone towards the north and/or the sun and/or the moon by an auxiliary means; and,
e. presenting said calculated direction on the telephone's screen.

56. The method according to claim 55, wherein the calculations are adapted to calculate a first coordinate; a second coordinate and the angel teta between said two coordinates; wherein said first coordinate is between the user's current site and the calculated North pole and/or the sun, and/or the moon; wherein said second coordinate is between said user's current site and the predetermined geographical site.

57. The method according to claim 56, comprising the step of presentation of said teta angle.

58. The method according to claim 56; wherein a presentation comprising the calculated north and/or south pole and/or the direction of the sun and/or the direction of the moon, the predetermined geographical site and said teta angle is obtained; so the teta angle which is presented is in coordination to the sun and/or the moon.

59. The method according to claim 55, wherein the calculations are made by a means of a processor in communication with said cellular telephone, or by a means of a processor integrated in the cellular telephone.

60. The method according to claim 55, comprising the step of sending a presentation selected from an illustration, animation or an SMS from a remote site to the user's cellular telephone; said presentation, comprising indication of calculated north and the desired predetermined geographical site.

61. The method according to claim 55, wherein the indication of the desired predetermined geographical site is provided by either a delivering SMS massage, drawing arrows, indicating the calculated teta degree, displaying a text or any combination thereof.

62. The method according to claim 55, wherein the auxiliary means is selected from integrated or non-integrated compass, GPS or any other means adapted to display the north or the magnetic north.

63. A method of doing business by either tenanting or selling means for locating the direction between a user's site to a predetermined geographical site by means of a cellular telephone to an advertiser, so said advertiser's predetermined location is essentially listed in the menu of the cellular telephone, in the manner users are being exposed to both said advertisers ability to sale its products and/or services; and/or to said advertiser's nearest sites.

64. The method according to claim 63, comprising the step of enlisting at least one advertiser's predetermined parameters, selected from its location or at least one other commercial properties in the menu of the cellular telephone.

65. The method according to claim 63, comprising the step of displaying or playing at least one advertisement selected from the advertiser's trademarks, logos, music or sounds to be connected by the user with said advertiser; to its products and/or services and/or to said advertiser's nearest sites.
